(19) United States
(12) Patent Application Publication
(10) Pub. No.: US 2020/0205372 A1
(43) Pub. Date: Jul. 2, 2020

(54) ADJUSTABLE PET HARNESS WITH RIGID LIFTING COMPONENTS

(71) Applicant: Bernadette Anderson, Chicago, IL (US)

(72) Inventor: Bernadette Anderson, Chicago, IL (US)

(21) Appl. No.: 16/235,544

(22) Filed: Dec. 28, 2018

(51) Int. Cl. A01K 1/02; A01K 27/00

(52) U.S. Cl. CPC A01K 1/0263; A01K 1/029; A01K 27/002

(57) ABSTRACT

An adjustable pet harness with rigid lifting components is disclosed. An example pet harness comprises a sling, first and second lifting rods, and first and second retainers. The sling defines first and second end loops. The first lifting rod is disposed in the first end loop. The first retainer extend through the sling and the first lifting rod to secure the first lifting rod in the first end loop. The second lifting rod is disposed in the second end loop. The second retainer extends through the sling and the second lifting rod to secure the second lifting rod in the second end loop.

### TECHNICAL FIELD

The present disclosure generally relates to devices and methods for lifting animals and, more specifically, to adjustable pet harnesses with rigid lifting components.

### BACKGROUND

In recent years, garments for controlling animals have been developed to securely fit onto animals and equipped with connecting devices (e.g., rings, buckles, loops, etc.) to link with leashes, leads, safety belts, etc. Garments for controlling animals are often worn about a body part (e.g., neck, torso, etc.) of the animal being controlled. Garments for controlling animals often make exercising animals more enjoyable for animal owners and more comfortable for the animals.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

In an embodiment, a pet harness comprises a sling, first and second lifting rods, and first and second retainers. The sling defines first and second end loops. The first lifting rod is disposed in the first end loop. The first retainer extends through one or both of the sling and the first lifting rod to secure the first lifting rod in the first end loop. The second lifting rod is disposed in the second end loop. The second retainer extends through one or both of the sling and the second lifting rod to secure the second lifting rod in the second end loop.

In another embodiment, a pet harness comprises a sling, a set of length-adjusting fasteners, first and second lifting rods. The sling is configured to pleat. The set of length-adjusting fasteners is disposed on the sling to secure the sling in a pleated position. The first and second lifting rods are secured to opposite ends of the sling.

In another embodiment, a pet harness comprises a sling, a lifting rod, and a retainer cord. The sling defines an end loop. The lifting rod is disposed in the end loop. The retainer cord is laced through the sling and the lifting rod to secure the lifting rod in the loop.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a top schematic view of a pet harness in accordance with the teachings of this disclosure.

FIG. 2 is a bottom schematic view of the pet harness of FIG. 1.

FIG. 3 is an enlarged view of zone 3 of FIG. 1.

FIG. 4 is a schematic cross-sectional view of the pet harness of FIG. 1 taken along line 4-4 of FIG. 1.

FIG. 5 is a schematic end view of the pet harness of FIG. 1 in a fastened state.

FIG. 6 is a schematic side view of the pet harness of FIG. 1 in the fastened state about a pet.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Animal control garments include collars, harnesses, and muzzles, among others. Collars are worn about the neck of an animal to provide a connection point for a leash and/or identification devices (e.g., tags, plates, radio frequency identification chips, etc.). Harnesses are worn about the torso of the animal to provide one or more connection points for a leash, tuglines (e.g., for a dog sled), handle (e.g., for a guide dog), etc. Muzzles are worn about the snout of the animal to prevent the animal from opening its mouth (e.g., to protect the animal from poisoned vermin bait, to prevent biting, to control the animal's diet, etc.).

Traditionally, pet harnesses are formed of flexible interconnected straps (e.g., nylon webbing, leather, canvas, etc.). The straps are connected to one another to fit around the animal. In some instances, the flexible straps are equipped with detachable fasteners (e.g., buckles, snaps, etc.) to facilitate donning and removal of the pet harness onto and from the animal. Pet harnesses are manufactured in different sizes for different-sized animals. In some instances, pet harnesses are custom-fit to animals (e.g., sled dogs). However, traditional pet harnesses do not provide an insulative covering (e.g., a jacket), offer limited size adjustability, and lack rigid components to help owners in lifting their animals (e.g., up and down stairs, into and out of a vehicle, etc.).

This disclosure describes an adjustable pet harness with rigid lifting components. By adjusting the pet harness, the pet harness may be worn by animals of more greatly differing sizes. By providing rigid lifting components, the weight of the animal may be spread over a larger surface area of the pet harness, thus preventing the pet harness from pinching or cutting into the animal.

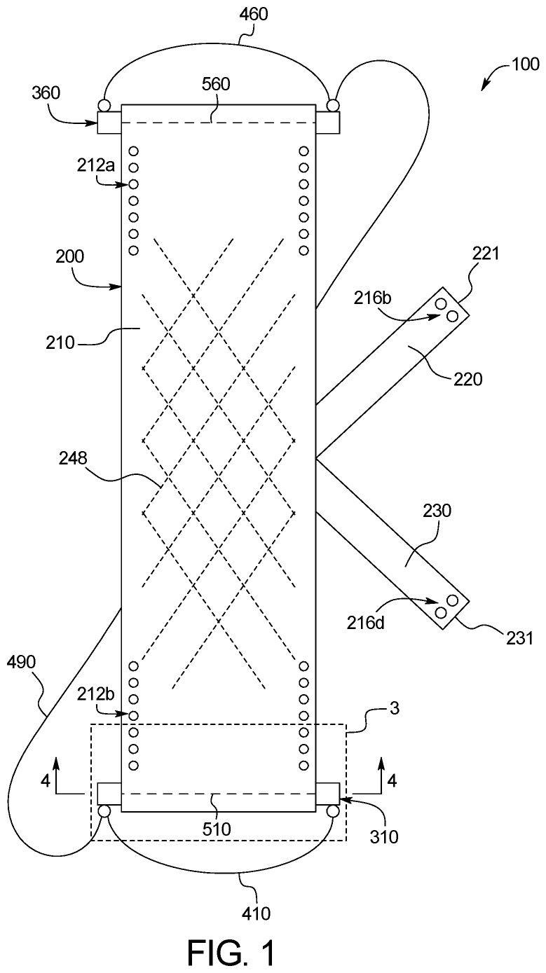

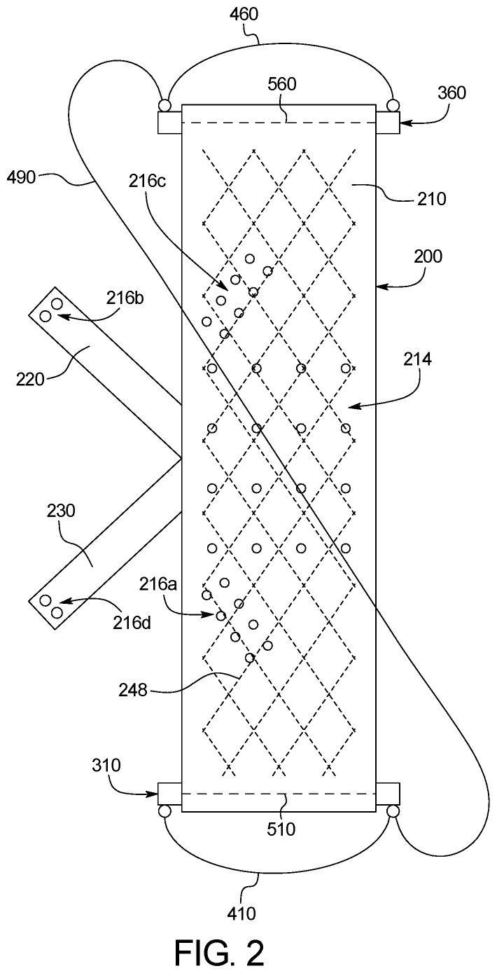

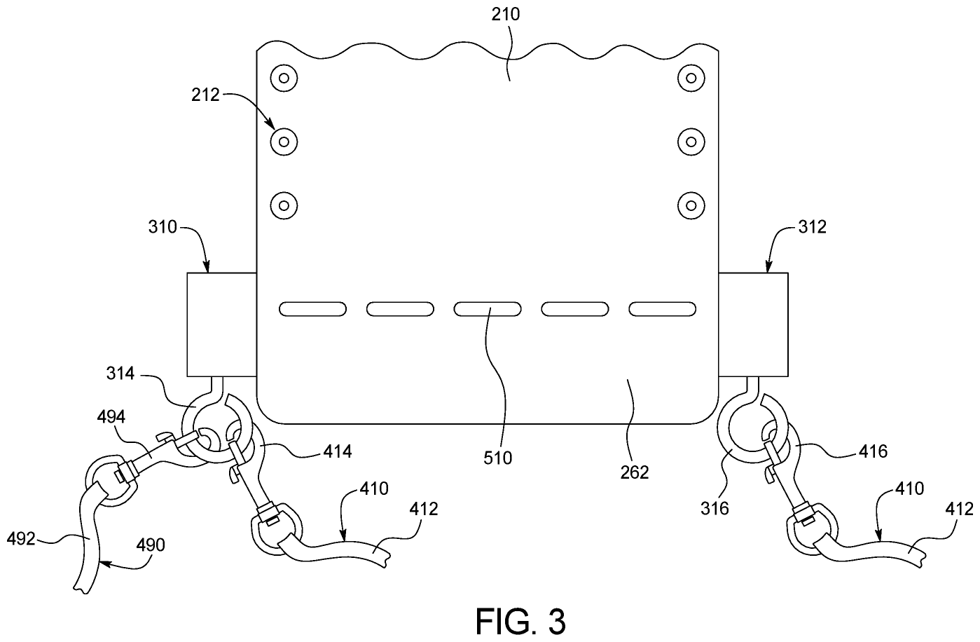

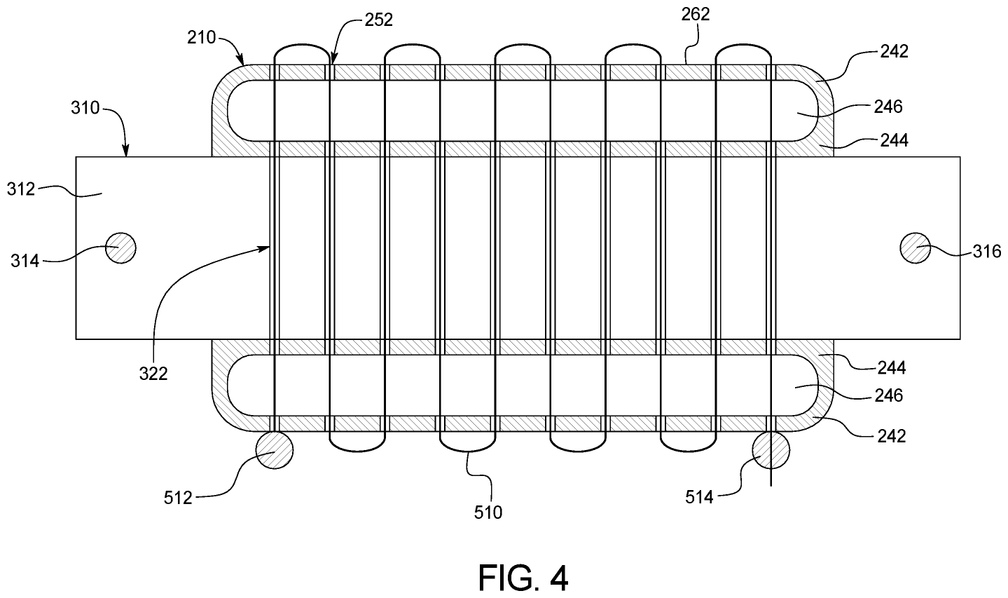

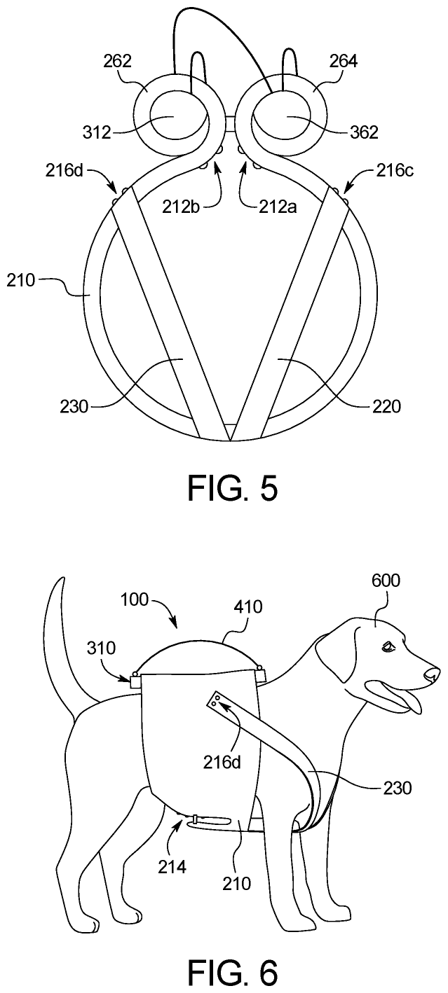

FIG. 1 is a top schematic view of a pet harness 100 in accordance with the teachings of this disclosure. FIG. 2 is a bottom schematic view of the pet harness 100. FIG. 3 is an enlarged view of zone 3 of FIG. 1. FIG. 4 is a cross-sectional view of the pet harness 100 taken along line 4-4 of FIG. 1. FIG. 5 is an end view of the pet harness 100 in a fastened state. FIG. 6 is a side view of the pet harness 100 of FIG. 1 in the fastened state about a pet 600.

As shown in FIGS. 1 and 2, the pet harness 100 includes a sling assembly 200, a first lifting rod assembly 310, a second lifting rod assembly 360, a first hand strap assembly 410, a second hand strap assembly 460, a shoulder strap assembly 490, a first retainer 510, and a second retainer 560.

The sling assembly 200 includes a sling 210, a first set of girth-adjusting fasteners 212a, a second set of girth-adjusting fasteners 212b, a set of length-adjusting fasteners 214, a first set of shoulder-adjusting fasteners 216a, a second set of shoulder-adjusting fasteners 216b, a third set of shoulder-adjusting fasteners 216c, a fourth set of shoulder-adjusting fasteners 216d, a first shoulder strap 220, and a second shoulder strap 230.

The sling 210 can have any desired shape, such as generally rectangular, and is configured to wrap around the torso of the pet 600. As shown in FIGS. 4 and 5, the sling 210 is stitched back upon itself to define a first end loop 262 and a second end loop 264. The sling 210 is substantially flexible to fold, roll, wrap, pleat, etc.

The first and second sets of girth-adjusting straps 212a, b are disposed at opposing ends of the sling 210. The first and second sets of girth-adjusting fasteners 212a, b correspond and connect to one another to form a closed loop of the sling 210, as shown in FIGS. 5 and 6. The first and second sets of girth-adjusting fasteners 212a, b secure the sling 210 about the torso of the pet 600, as shown in FIG. 6. The first and second sets of girth-adjusting fasteners 212a, b provide a plurality of positions at which the sling 210 may be secured about the pet 600. Thus, the first and second girth-adjusting fasteners 212a, b provide adjustability to fit the pet harness 100 about pets (e.g., pet 600) of varying girths. In the examples of FIGS. 1-6, the first and second sets of girth-adjusting fasteners 212a, b are shown as male and female snaps. It should be understood that any type of releasable fastener may be used as the first and second sets of girth-adjusting fasteners 212a, b (e.g., buttons and buttonholes in the sling 210, buckles, hooks and eyes, etc.). Each of the girth-adjusting fasteners 212a can be located at equal distances from a first end of the sling 210 as the corresponding girth-adjusting fasteners 212b from the second end of the sling 210.

The length-adjusting fasteners 214 are disposed along a portion of the sling 210. In the examples of FIGS. 1-6, the length-adjusting fasteners 214 are disposed in the middle of the sling 210. The length-adjusting fasteners 214 correspond and connect to one another to fold the sling 210 back on itself, as shown in FIGS. 5 and 6. Thus, the area of sling 210 contacting the belly of the pet 600 is reduced, as shown in FIG. 6. In other words, the length-adjusting fasteners 214 provide a plurality of positions at which the sling 210 may be pleated. Thus, the length-adjusting fasteners 214 provide adjustability to fit the pet harness 100 to pets (e.g. pet 600) of varying lengths. In other words, the length-adjusting fasteners 214 reduce a dimension of (e.g., shorten) the sling 210. In the examples of FIGS. 1-6, the set of length-adjusting fasteners 214 are shown as male and female snaps. It should be understood that any type of releasable fastener may be used as the set of length-adjusting fasteners 214 (e.g., buttons and buttonholes in the sling 210, buckles, hooks and eyes, etc.).

The first and second shoulder straps 220, 230 extend from the sling 210. Ends 221, 231 of the first and second shoulder straps 220, 230 removably and adjustably attach to the sling 210 via the first, second, third, and fourth sets of shoulder-adjusting fasteners 216a-d. Thus, the pet harness 100 removably wraps around the chest of the pet 600 to removably attach to the sling 210. In other words, the first and second shoulder straps 220, 230 secure the pet harness 100 about the shoulders of the pet 600.

The first and third sets of shoulder-adjusting fasteners 216a, c are disposed on the sling 210. The second set of shoulder-adjusting fasteners 216b is disposed on the end 221 of the first shoulder strap 220. The fourth set of shoulder-adjusting fasteners 216d is disposed on the end 231 of the second shoulder strap 230. The first and second sets of shoulder-adjusting fasteners 216a, b correspond and connect to one another. The third and fourth sets of shoulder-adjusting fasteners 216c, d correspond and connect to one another. The first and second sets of shoulder-adjusting fasteners 216a, b provide a plurality of positions at which the first shoulder strap 220 may be removably attached to the sling 210. The third and fourth sets of shoulder-adjusting fasteners 216c, d provide a plurality of positions at which the second shoulder strap 230 may be removably attached to the sling 210. Thus, the first, second, third, and fourth shoulder-adjusting fasteners 216a-d provide adjustability to fit the pet harness 100 to pets (e.g. pet 600) of varying statures. In the examples of FIGS. 1-6, the first, second, third, and fourth sets of shoulder-adjusting fasteners 216a, b, c, d are shown as male and female snaps. It should be understood that any type of releasable fastener may be used as the first, second, third, and fourth sets of shoulder-adjusting fasteners 216a, b, c, d (e.g., buttons and buttonholes in the sling 210, buckles, hooks and eyes, etc.).

In the examples of FIGS. 1-6, the sling 210 is made of a quilted material. As shown in FIG. 4, the sling 210 includes a first layer 242, a second layer 244, and a third layer 246. The third layer 246 is between the first and second layers 242, 244. The first and second layers 242, 244 are intermittently attached to one another with stitching 248 to encapsulate the third layer 246. The first and second layers 242, 244 may be made of a durable and/or water-resistant material (e.g., canvas, denim, oilcloth, polyester, nylon, rubberized fabric, etc.). The third layer 246 may be made of an insulative material (e.g., polyester batting, flannel, fleece, wool, down, etc.).

As shown in FIGS. 1 and 2, the first and second lifting rod assemblies 310, 360 are disposed at opposite ends of the sling 210. It should be appreciated that the first and second lifting rod assemblies 310, 360 are substantially identical. All features described herein with respect to the first lifting rod assembly 310 are therefore also included in the second lifting rod assembly 360. As shown in FIG. 3, the first lifting rod assembly 310 includes a lifting rod 312, a first attachment hook 314, and a second attachment hook 316.

The sling 210 is wrapped and secured around the first and second lifting rods 312, 362. More specifically, the first lifting rod 312 is secured in the first end loop 262 and the second lifting rod 362 is secured in the second end loop 264.

As shown in FIGS. 3 and 4, the first and second attachment hooks 314, 316 are engaged (e.g., threadably, adhesively, etc.) with the first lifting rod 312 at opposing ends of the first lifting rod 312. The first hand strap 410 attaches to the first lifting rod assembly 310 via the first and second attachment hooks 314, 316. The shoulder strap 490 attaches to the first lifting rod assembly 310 via the first attachment hook 314.

As shown in FIG. 4, the first lifting rod 312 defines a plurality of openings 322 extending through the first lifting rod 312. The sling 210 defines a corresponding plurality of openings 252. The first retainer 510 is inserted through the sling 210 and through the first lifting rod 312 to prevent the first lifting rod 312 from rotating relative to the sling 210. In the examples of FIGS. 1-6 the retainer 510 is a cord that is threaded in an undulating pattern through the sling 210 and the first lifting rod 312. In other words, in the examples of FIGS. 1-6, the retainer 510 is laced through the sling 210 and the first lifting rod 312. In some examples, the retainer 510 includes a stopper 512 and a removable cincher 514 to secure the retainer 510 in the assembled lifting rod 312 and sling 210. It should be appreciated that a retainer may be any anti-rotation device (e.g., one or more rings, pegs, zip ties, etc.). It should further be appreciated that a retainer can be configured for permanently or removably securing a rod to a sling or a portion thereof (such as a loop or end of a sling).

As shown in FIG. 3, the first hand strap assembly 410 includes a strap 412, a first buckle hook 414, and a second buckle hook 416. The first buckle hook 414 removably attaches to the first attachment hook 314. The second buckle hook 416 removably attaches to the second attachment hook 316. The second hand strap 460 likewise attaches to the second lifting rod assembly 360. As shown in FIG. 3, the shoulder strap 490 includes a shoulder strap 492 a third buckle hook 494, and a fourth buckle hook (not shown). It should be understood that the third buckle hook 494 and the fourth buckle hook are substantially identical. The third buckle hook 494 removably attaches to the first attachment hook 314. The fourth buckle hook likewise removably attached to the second lifting rod assembly 360. In some instances, the shoulder strap 490 is attached to diagonally opposing (e.g., kitty corner) ends of the first and second lifting rod assemblies 310, 360, as shown in FIGS. 1-2.

As shown in FIGS. 5 and 6, in operation, the sling 210 may be rolled around the first and second lifting rod assemblies 310, 360 to shorten the sling 210. It should be appreciated that first and second retainers 510, 560 respectively work to prevent the sling 210 from unwinding about the first lifting rod 312 and the second lifting rod 362 when tension is applied to the sling 210 via the first and second lifting rod assemblies 310, 360. In other words, the first and second retainers 510, 560 keep the sling 210 from unspooling around the first and second lifting rods 312, 362.

As shown in FIGS. 5 and 6, once the sling 210 is wrapped about the first and second lifting rods 312, 362, the first and second girth-adjusting fasteners 212a, b may be connected to one another to secure the pet harness 100 about the torso of the pet 600. Further, the first and second shoulder straps 220, 230 may be wrapped around the chest and shoulders of the pet 600 and secured with the shoulder-adjusting fasteners 216a-d. In the example of FIG. 6, the pet 600 is shown as a dog. It should be understood that the pet harness 100 may be used with any four-legged pet (e.g., a cat, a goat, a miniature pig, etc.).

In operation, a pet owner may lift the pet 600 by the first hand strap 410, the second hand strap 460, and/or the shoulder strap 490. Additionally, the pet owner may carry the pet 600 by the first hand strap 410, the second hand strap 460, and/or the shoulder strap 490. The shoulder strap 490 is adjustable and is configured to be worn about the pet owner or over one shoulder of the pet owner. A leash may be attached to one or more of the attachment hooks (e.g., first attachment hook 314).

It should be understood and appreciated that the first and second lifting rods 312, 362 work to evenly distribute tension applied to the pet harness by the straps 410, 460, 490, a leash, a handle, etc. Because the first and second lifting rods 312, 362 are substantially rigid, an upward force to lift the pet 600 is spread evenly across the surface area of the sling 210. Thus, the sling 210 does not cut into or pinch the pet 600 and the pet 600 may be comfortably lifted and/or carried in the pet harness 100.

The present disclosure also provides methods for lifting and transporting a pet using a pet harness as described herein. The methods can comprise placing a pet in a sling of a pet harness and adjusting a dimension of the sling based on the size and/or shape of the pet. The adjusting step can be done before, during, or after the placing step. The adjusted dimension of the sling can be its length, for instance, by use of the length-adjusting fasteners 214, or its circumference, for instance, by use of the girth-adjusting fasteners 212a, 212b. The methods can also comprise removably wrapping one or more shoulder straps around the pet or otherwise securing the torso or the chest of the pet in the pet harness.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

From the foregoing, it should be appreciated that the above disclosed apparatus may aid pet owners by allowing pet owners to more comfortably lift their pets (e.g., into and out of a vehicle, up and down stairs, etc.). By aiding pet owners to more comfortably carry their pets, pet owners may more easily navigate obstacles (e.g., stairs) while on an outing with a pet. Further, the increased lifting surface area provided by the above disclosed apparatus may improve comfort for the pet being lifted.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A pet harness comprising:
a sling defining first and second end loops;
a first lifting rod disposed in the first end loop;
a first retainer extending through one or both of the sling and the first lifting rod to secure the first lifting rod in the first end loop;
a second lifting rod disposed in the second end loop;
a second retainer extending through one or both of the sling and the second lifting rod to secure the second lifting rod in the second end loop.

2. The pet harness of claim 1, wherein the sling is configured to wrap around the first and second lifting rods to shorten the sling.

3. The pet harness of claim 1, wherein the sling includes first and second sets of girth-adjusting fasteners.

4. The pet harness of claim 3, wherein the sling is configured to be secured about a pet via the girth-adjusting fasteners.

5. The pet harness of claim 1, further comprising first and second shoulder straps extending from the sling.

6. The pet harness of claim 5, wherein ends of the first and second shoulder straps adjustably attach to the sling via shoulder-adjusting fasteners.

7. The pet harness of claim 1, wherein the sling is quilted.

8. A pet harness comprising:
a sling configured to pleat;
a set of length-adjusting fasteners disposed on the sling to secure the sling in a pleated position; and
first and second lifting rods secured to opposite ends of the sling.

9. The pet harness of claim 8, wherein the sling is configured to wrap around the first and second lifting rods to shorten the sling.

10. The pet harness of claim 8, wherein the sling includes first and second sets of girth-adjusting fasteners.

11. The pet harness of claim 10, wherein the sling is configured to be secured about a pet via the girth-adjusting fasteners.

12. The pet harness of claim 8, further comprising first and second shoulder straps extending from the sling.

13. The pet harness of claim 12, wherein ends of the first and second shoulder straps adjustably attach to the sling via shoulder-adjusting fasteners.

14. The pet harness of claim 8, wherein the sling is quilted.

15. A pet harness comprising:
a sling defining an end loop;
a lifting rod disposed in the end loop;
a retainer cord laced through the sling and the lifting rod to secure the lifting rod in the loop.

16. The pet harness of claim 15, wherein the sling is configured to adjustably pleat and further comprising a set of length-adjusting fasteners to secure the sling in a pleated position.

17. The pet harness of claim 15, further comprising first and second sets of girth-adjusting fasteners.

18. The pet harness of claim 15, wherein the sling is configured to wrap around the lifting rod to shorten the sling.

19. The pet harness of claim 15, further comprising first and second shoulder straps extending from the sling, wherein respective ends of the first and second shoulder straps are configured to adjustably attach to the sling via shoulder-adjusting fasteners.

20. The pet harness of claim 15, wherein the sling is quilted.
